(19) United States
(12) Patent Application Publication
(10) Pub. No.: US 2005/0046223 A1
(43) Pub. Date: Mar. 3, 2005

(54) Automotive sun visor extender

(76) Inventors: Kip E. Virts, Elk Grove, CA (US); Mark S. Virts, Austin, TX (US)

Correspondence Address: Hulsey Grether & Fortkort. LLP, 8911 N. Capital of Texas Hwy, Suite 3200, Austin, TX, 78759, US

(21) Appl. No.: 10/651,172

(22) Filed: Aug. 28, 2003

(51) Int. Cl. B60J 3/00

(52) U.S. Cl. 296/97.6

(57) ABSTRACT

Provided is a sun visor extender that slips over or is attach to a standard automobile or other vehicle sun visor and is configurable to increase the length of the standard sun visor. One embodiment is constructed of a rectangular piece of material, which, when folded over, forms a tube-like shape that slips over an existing sun visor. Another embodiment is a single piece tube or multiple tubes that fit into each other and “telescope” into an extended position. Another embodiment is a “clip-on” visor extender in which a piece of material is affixed to an existing sun visor by means of one or more clips. Another embodiment of a clip-on visor extender is made of a single piece of material and includes one or more lips that hook around an existing sun visor to affix the extender in a variety of positions.

### BACKGROUND OF THE INVENTION

1. Technical Field

The invention relates generally to an apparatus for protecting the eyes of a vehicle passenger or driver from the sun and, more specifically, to a portable sun visor that affixes to an existing sun visor in a passenger or commercial vehicle and is operable to extend the length of the existing visor.

2. Description of the Related Art

Certainly, the invention of the sun visor improved the comfort of automobiles and trucks for both passengers and drivers. When the sun is low enough in the sky to shine in a driver's eyes, driving can become dangerous due to limited visibility. In this situation, a typical sun visor is lowered and/or swung into place so that the visor blocks the incoming rays of the sun. However, the standard sun visor is often too short to block the sun at certain angles, e.g. central and very lateral angles, causing the driver or passenger who is using the visor either to look into the sun or shift the driving position so that the sun is blocked.

Some vehicle manufacturers have addressed this problem by installing an “internal” sun visor extender that fits in a slot in the visor and slides out of the slot, effectively increasing the length of the visor. However, there are problems with this approach. First, a visor must be manufactured with this option, increasing the cost of the visor. Also, since an internal visor extender is stored inside the visor, the extender must be narrower than the visor itself. The narrowness of the internal extender means that it can not provide the same angular protection as the external portion of the sun visor. In other words, there may be a gap between the top of the interior extender and the roof of the vehicle such that sun light passes at certain angles of the sun.

### SUMMARY

Provided is an apparatus and method for increasing the utility of a vehicle's sun visor. An “external” sun visor extender is configured to slip over a standard sun visor and is configurable to increase the length of the standard sun visor. When a driver or passenger of the vehicle slides the extender into an extended position, the length of the existing sun visor is increased and, as a result, the driver or passenger's eyes are protected from the glare of the sun more than otherwise possible with the existing sun visor itself.

One embodiment of the external sun visor extender is constructed of a rectangular piece of material, stiff enough to support its own length when folded over into a tube-like shape. The tube-like shape is then slipped over an existing sun visor where it can be positioned into either extended or unextended positions. A first strip of material affixed to one end of the rectangular piece of material attaches to a second strip of material affixed to the other end of the rectangular piece of material. One example of materials that may be used for the first and second strip of material are the two materials that comprise Velcro™. In another example, the two strips are sticky with respect to each other. In the alternative, the rectangular piece of material can be fastened into a tube-like shape by means of buttons and corresponding button holes, without a first and second piece of material.

In this manner, the external sun visor extender is fastened into the tube-like shape, or sleeve. The rectangular piece of material, in addition to being stiff enough to hold its shape, can be stretched so that the external sun visor extender can be fitted to existing sun visors of different width. In the alternative, the first strip and the second strip (or buttons and button holes) are capable of being attached to each other in different positions so that the width of the sun visor extender may be adjusted.

Another embodiment of the external sun visor extender is a simple, single piece, flattened tube, or sleeve, which is slipped over an existing sun visor. The extender may be stretchy, so that it can fit multiple size visors, or be manufactured in multiple sizes. In the alternative, there may be multiple tubes that fit into each other such that the tubes “telescope” with respect to each other, effectively increasing the length of the sun visor to which they are installed.

Another embodiment of the external sun visor is a “clip-on” visor extender in which a piece of material such as, but not limited to, cardboard or plastic is affixed to an existing sun visor by means of one or more clips. Another embodiment of a clip-on visor extender is made of a single piece of material such as plastic and includes two lips that hook around an existing sun visor to affix the extender in a variety of positions.

Another embodiment of a clip-on visor extender is formed of a flattened tube with one or more convex sides. The one or more convex sides serve to affix the sun visor extender to a sun visor by pinching the sun visor.

Each embodiment may also include printed information such as, but not limited to, date and time information, schedules, logos, advertisements, and warning information. The information is printed or otherwise affixed to a particular visor extender so that a driver or passenger of a vehicle can conveniently view the information. The visor extender may include a pocket so that a printed information sheet can be slipped into the pocket, thereby enabling a user to replace one set of information with another. The pocket may include a clear plastic window so that the information sheet is protected from the elements.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIGS. 1A and 1B illustrate an existing “internal” sun visor extender in a stored position (FIG. 1A) and an extended position (FIG. 2B).

FIGS. 2A and 2B illustrate another embodiment of the claimed sun visor extender both by itself (FIG. 2A) and installed on an existing vehicle sun visor (FIG. 2B).

FIGS. 3A and 3B illustrate a “telescoping,” external sun visor extender in a stored position (FIG. 3A) and an extended position (FIG. 3B).

FIG. 4 illustrates another embodiment of the claimed visor extender that clips onto an existing sun visor.

FIGS. 5A and 5B illustrate another embodiment of a clip-on sun visor extender.

FIGS. 6A and 6B illustrate another embodiment of a clip-on sun visor extender.

### DETAILED DESCRIPTION

Although described with particular reference to a automotive sun visor, the sun visor extender of the present invention can be implemented in any vehicle in which it is desirable to shield a driver or passenger's eyes from the sun at particular angles. In addition, a sun visor may be manufactured according to the disclosed principles such that the claimed subject matter is not an “add-on” product but is incorporated into a sun visor.

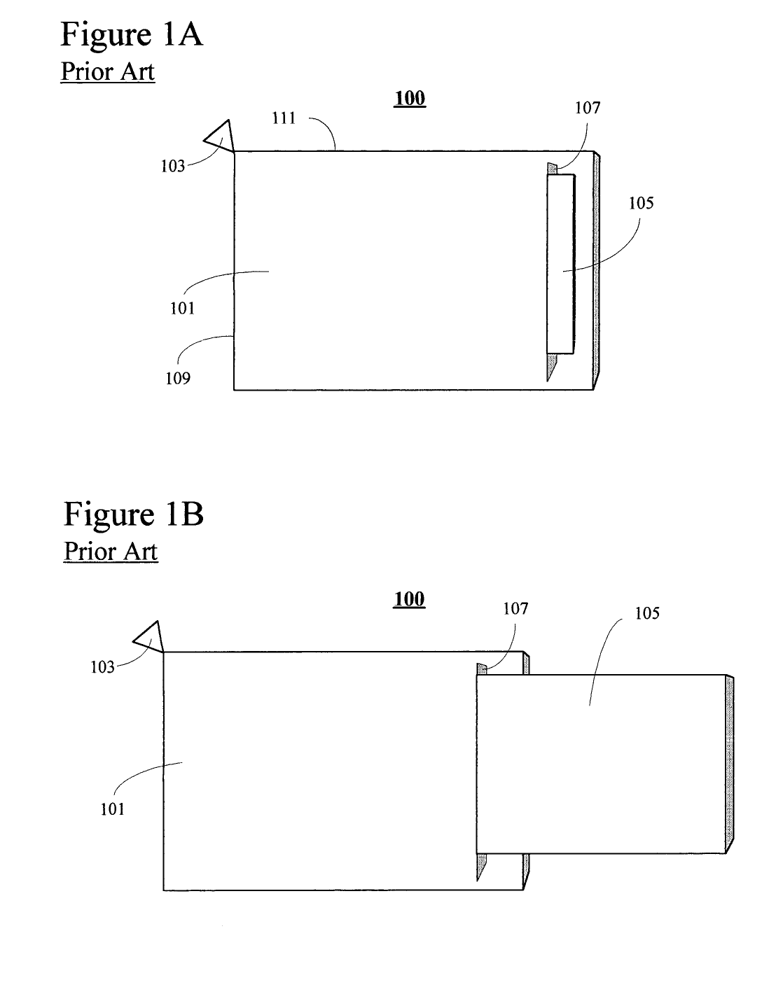

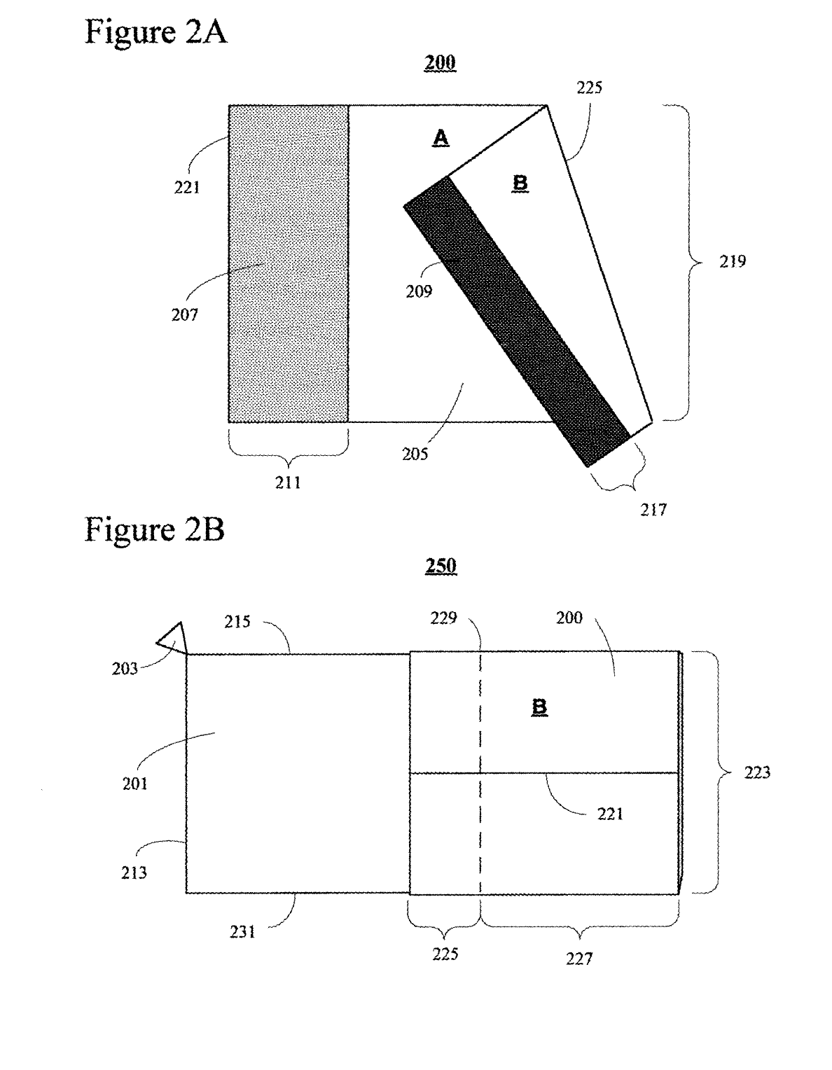

FIGS. 1A and 1B illustrate an existing “internal” sun visor extender 100 in an unextended, or “stored” position (FIG. 1A) and an extended position (FIG. 2B). Sun visor 100 includes a main body 101 and an internal portion 105. Internal portion 105 is typically plastic and slips into and out of a recess 107 in main body 101. In the stored position, internal portion 105 is slipped almost entirely into recess 107, with only enough of portion 105 showing so that portion 105 can be grabbed and pulled into the extended position. In the extended position, just enough of portion 105 is inserted in recess 107 to keep portion 105 from falling loose from main body 101.

A pivot point 103 attached to main body 101 enables visor 100 to be rotated around an edge 109 and an edge 111 and thus positioned with respect a bright source of light such as the sun or oncoming headlights so that visor 100 protects the eyes of a vehicle's passenger or driver. Pivot point 103 is typically attached to the inside of the roof of a vehicle (not shown). Those with experience with automobiles and/or other vehicles should be familiar with the operation of a typical sun visor and probably visor 100 as well.

FIGS. 2A and 2B illustrate a sun visor extender 200 both by itself (FIG. 2A) and in an installed position 250 on an existing vehicle sun visor 201 (FIG. 2B). Sun visor extender 200 is constructed on a main body 205, which has an interior surface A and an exterior surface B. Sun visor extender 200 is illustrated folded along an edge 225 so that both interior surface A and exterior surface B are displayed. In one embodiment, main body 205 is constructed of a flexible material such as, but not limited to, neoprene or Spandex®, first developed by E. I. du Pont de Nemours & Company in the 1950's, so that when in installed position 250 visor extender 200 pinches visor 201, thus keeping visor extender 200 from slipping off visor 201. In another embodiment, main body may be made of a material that can bent into a tube without breaking and provides enough friction between visor extender 200 and sun visor 201 to keep visor extender 200 from slipping off visor 201.

In an alternative embodiment, visor extender 200 may be build as a tube such that different sizes are manufactured for different size, existing visors or manufactured of a stretchy material so that “one size fits all.”

A strip of adhesive material 207 is affixed to interior surface A of main body 205 and a strip of adhesive material 209 is affixed to exterior surface B of main body 205. Strips 207 and 209 can be any materials that are capable of sticking to each other, such as the two types of material that make up Velcro®, patented by George de Mestral in 1955. In one embodiment, strips 207 and 209 may both be a type of glue that sticks to itself and can be repeatably suck and unstuck. In another embodiment, strips 207 and 209 may be able to be attached to each other only once so that once a user has folded and thus “sized” visor extender 200 to a particular vehicle, extender simply slides on and off visor 201. Strips 207 and 209 may even represent a series of buttons and button holes. One with skill in the art should recognize the existence of several methods by which the two sides of main body 205 can be affixed to each other.

By folding main body 205 over so that strip 209 sticks to strip 207, a tube is formed, with side A on the inside and side B on the outside. In this embodiment, strip 207 has a width 211, which is larger than a width 217 of strip 209. Because strip 207 is wider than strip 209, strip 209 can be placed at various positions with respect to strip 207, thus providing a variable width 223 for use with different, existing sun visors of different widths and shapes. By varying the width of visor extender 201, a user can modify the grip visor extender 200 exerts on visor 201 when in installed position 250.

FIG. 2B illustrates visor extender 200 wrapped around conventional visor 201 so that an edge 221 of main visor 201 runs parallel or approximately parallel to an edge 215 of visor 201. In some visors, edge 215 is not parallel to an opposing edge 231 and therefore an edge 213 is longer than an edge 229 (shown here as a dotted line because a corresponding portion of visor 201 is obscured by visor extender 200). In other words, visor 201 may not be rectangular.

Like visor 101 (FIG. 1), visor 201 is attached to a vehicle (not shown) by means of a pivot point 203, which enables visor 201 to be rotated around either edge 213 or edge 215. Strips 207 and 209 cannot be seen in FIG. 2B because they are on the inner side of visor extender 200, which is formed into a tube as explained above. The degree to which visor extender 200 effectively lengthens visor 201 depends upon how much of visor 201 is contained within the tube of visor extender 200. In a fully retracted position, visor extender 200 is positioned entirely within the length of visor 201 and thus does not extend visor 201 at all. Dotted line 229 indicates an edge of visor 201 that is obscured by visor extender 200. In a fully extended position, a portion 225 of visor extender 200 encloses only enough of visor 201 to keep from falling off visor 201. In other words, visor extender 200 is able to effectively increase the length of visor 201 by a portion 227 of visor extender's length, i.e. length 219 of visor 201 minus the length of portion 225, which is necessary to grip visor 201. Visor extender 200 is made of material flexible and thick enough that when in extended position 250, portion 225 is able to grip visor 201 regardless of the width of visor 201 at any particular point and portion 227 maintains its shape and does not hang down.

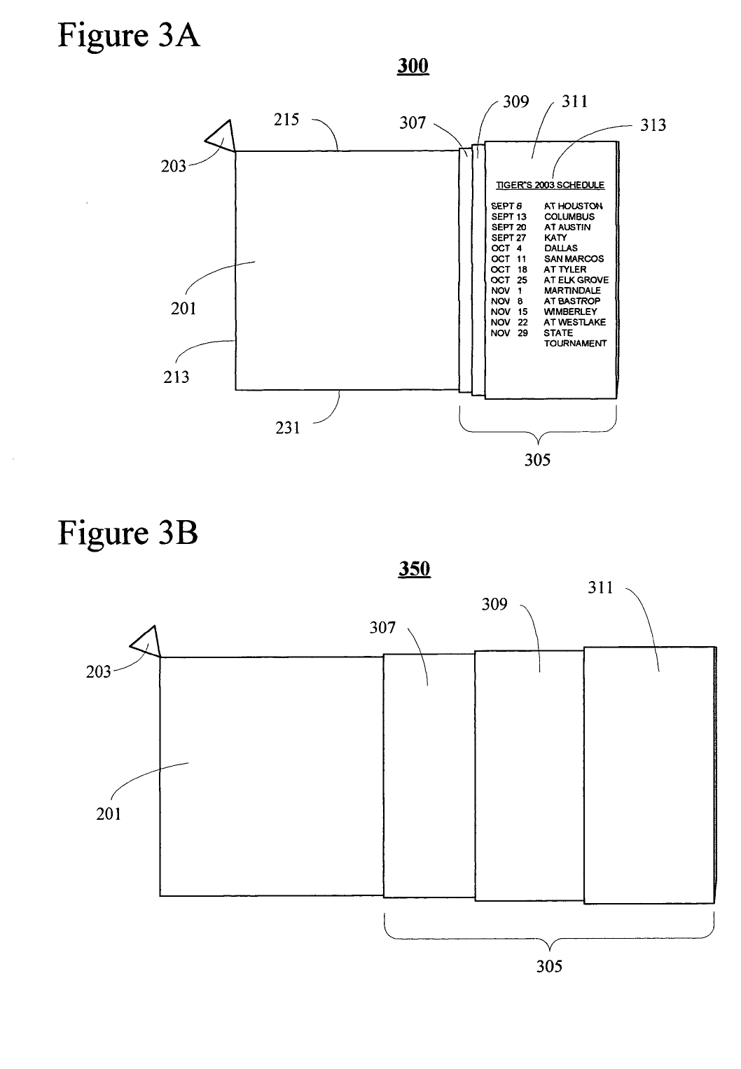

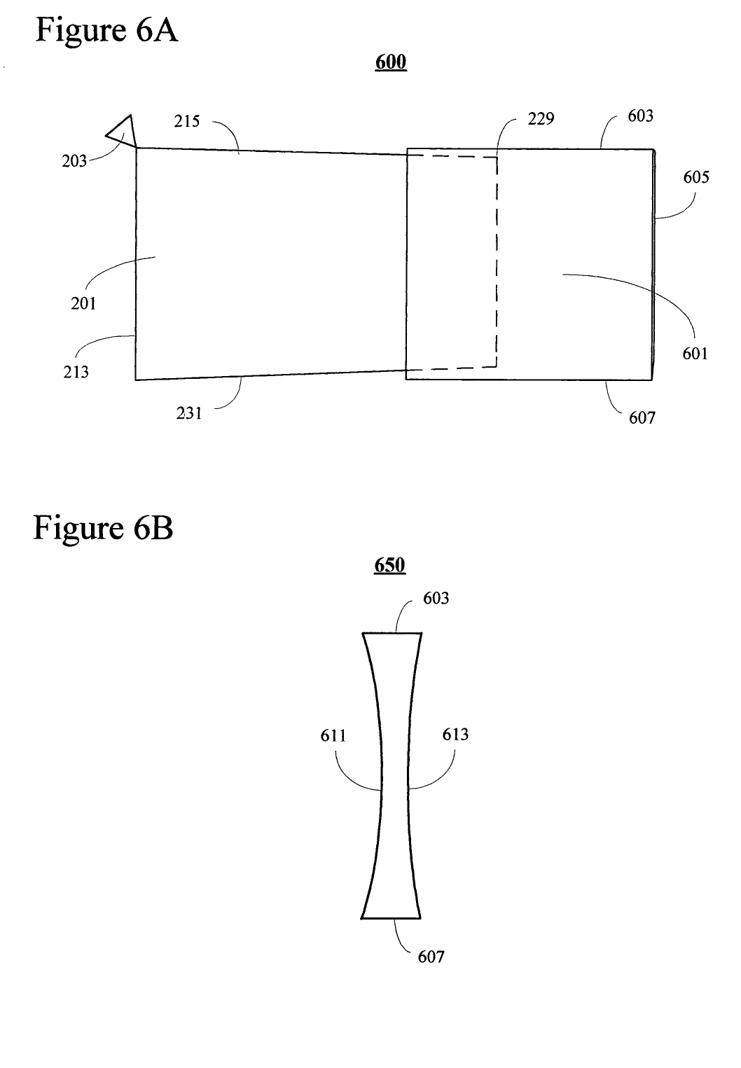

FIGS. 3A and 3B illustrate another embodiment, or “telescoping,” external sun visor extender 305 in a stored position 300 (FIG. 3A) and an extended position 350 (FIG. 3B). Existing visor 201, explained above in conjunction with FIG. 2, is attached by means of pivot point 203 so that it can rotate around edges 213 and 215. Telescoping visor extender 305 includes one or more sections, e.g. three sections 307, 309 and 311. Section 307 is slightly wider that visor 201 so that section 307 is able to slide on visor 201. Section 307 is not so much wider than visor 201 that section 307 falls off visor 201. Like visor extender 200, section made be made of Spandex® so that section grips visor 201 when installed or simply made of some material such as a paper product (e.g. cardboard) or plastic and held on by means of friction or compression (see FIG. 6).

Section 309 is slightly wider than section 307 and section 311 is slightly wider than section 309. In both cases, the wider section 309 or 311 slides over the more narrow section 307 or 309, respectively, with enough friction or compression to be held in either the retracted position 300 or the extended position 350. In retracted position 300, the effective increase in length of visor 201 is relatively small or nonexistent. In extended position 350, the effective increase in length of visor 201 is equal the sum of the individual lengths of sections 307, 309 and 311, minus an amount necessary to enable the sections 309 and 311 to grip sections 307 and 309, respectively, and for section 307 to grip visor 201.

Section 311 of visor extender 305 includes information 313 pertaining to a local sports team's schedule. Many types of information can be displayed on visor extender 305 such as, but not limited to time and date information, logos, advertisements and warning information. Although not shown in FIG. 2, visor extender 200 could also include information printed upon side B so that a driver or passenger of a vehicle so equipped can conveniently read or view the information.

In an alternative embodiment, information is displayed in a pocket (not shown) incorporated into visor extender 305 such that a printed information sheet may be slipped into and out of the pocket. In this manner, a user of visor extender 305 can replace one set of information with another set. In addition, the pocket may include a clear window through which an installed sheet of information is viewed, thus protecting the sheet from the elements.

Like visor extender 200, each of sections 307, 309 and 311 may be a one-piece tube, manufactured in different sizes to fit different size existing visors or, in the alternative, manufactured like visor extender 200 so that “one size fits all.”

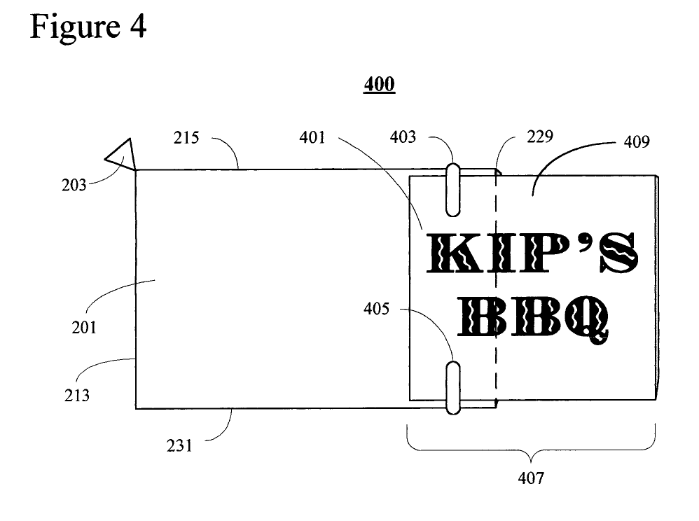

FIG. 4 illustrates another embodiment, or a “clip-on” sun visor extender 401. Clip-on visor extender 401 is constructed of a stiff material such as, but not limited to, a paper product (e.g. cardboard) or plastic. Sun visor 201, pivot point 203, edges 213, 215 and obscured edge 229 are the same as described above in conjunction with FIGS. 2 and 3. One or more clips, in this example two clips 403 and 405, hold clip-on extender 401 to sun visor 201 by pinching the two 201 and 401 together. In this manner, clip-on extender 401 extends the effective length of visor 201 by clip-on extender's 401 length 407, minus whatever length of material is necessary for clips 403 and 405 to pinch against visor 201. Like visor extenders 200 (FIG. 2) and 305 (FIG. 3), visor extender 401 can be positioned in a variety of positions, including a stored position (not shown) and an extended position 400.

Visor extender 401 also includes a printed advertisement 409, specifically the phrase “KIP'S BBQ.” As explained above in conjunction with FIG. 3, may types of information can be printed on visor extender 401 as well as other embodiments of the claimed subject matter, including, but not limited to, sports schedules, logos, advertisements and warning information. It should be noted that information 409 is information other than product information typically found upon manufactured items, such as the sun visor extender's trade name, patent number or place of manufacture. In other words, information 409 communicates information unrelated to sun visor extender 401 itself.

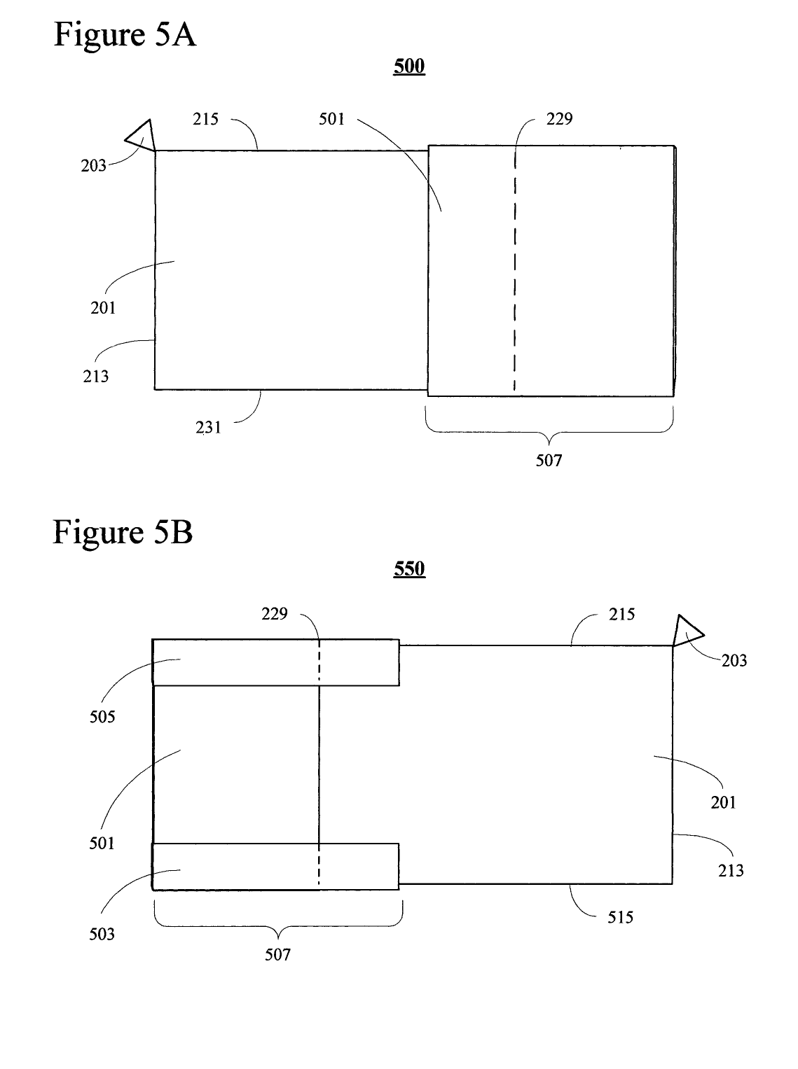

FIGS. 5A and 5B illustrate another clip-on sun visor extender 501, which in this Figure is installed on sun visor 201 (FIGS. 2-4). FIGS. 5A and 5B show visor 201 and clip-on extender 501 from a front position 500 and a back position 550, respectively. Sun visor 201, pivot point 203 and edges 213, 215 and 229 are the same as described above in conjunction with FIGS. 2-4. In back position 550, edge 229 of visor 201 is partially obscured, as indicated by dotted lines, and partially visible, as indicated by a solid line.

In back position 550, two lips 503 and 505 of clip-on extender 501 are visible. Lip 503 folds over edge 215 of visor 201 and lip 505 folds over an edge 515 of visor 201. Lips 503 and 505 serve to hold extender 501 to visor 201. Although in FIG. 5B lips 503 and 505 are illustrated extending the entire length of clip-on extender 501, either one or both of lips 503 and 505 may extend only a portion of the length of clip-on extender 501. In this example, clip-on extender 501 extends the effective length of visor 201 by clip-on extender's 501 length 507, minus whatever length of lips 503 and 505 are necessary to affix clip-on extender 501 to visor 201. Like visor extenders 200 (FIG. 2), 305 (FIG. 3), and 401 (FIG. 4), visor extender 501 can be positioned in a variety of positions, including a stored position (not shown) and an extended position, as illustrated in both FIGS. 5A and 5B.

FIGS. 6A and 6B illustrate another clip-on visor extender 601 which affixes to visor 201 by means of compression. Visor extender 601 includes edges 603 and 607 that are approximately parallel to edges 215 and 231 of visor 201, which, in this illustration, are shown to be non-parallel. An end 605 of visor extender 601 is shown head-on in FIG. 6B.

FIG. 6B illustrates the head-on view of visor extender 601, including edges 603 and 607. Also illustrated is an edge of a front surface 611, which is the majority of sun visor extender 601 seen in FIG. 6A, and an edge of a back surface 613, which is obscured in FIG. 6A by the position of visor extender 601. In this illustration, front surface 611 and back surface 613 are concave so that together visor 201 is pinched between surfaces 611 and 613, thus affixing visor extender 601 in selected positions along visor 201. In an alternative embodiment, only one of surfaces 611 and 613 is concave. In these two embodiments, visor extender 601 is constructed of material sufficiently rigid to maintain the concave nature of relevant surfaces 611 and/or 613.

While various embodiments of the application have been described, it will be apparent to those of ordinary skill in the art that many more embodiments and implementations are possible that are within the scope of this invention. Accordingly, the invention is not to be restricted except in light of the attached claims and their equivalents.

1. A sun visor extender, comprising:
a piece of material;
a first fastener strip affixed to a first end of the piece of material; and
a second fastener strip affixed to a second end of the piece of material, opposite the first end and on the opposite side of the piece of material as the first end;
wherein the first fastener strip and the second fastener strip are operable to attach to each other such that the piece of material is formed into a flattened tube and;
wherein the tube is operable to slide over an existing sun visor such that in an extended position a portion of the tube is operable to grip the existing sun visor, thereby increasing the effective length of the existing sun visor by a length equal to a potion of tube not gripping the existing sun visor.

2. The sun visor extender of claim 1, further comprising information, unrelated to the sun visor extender, printed upon the piece of material such that the information is viewable when the sun visor extender is affixed to the sun visor.

3. The sun visor extender of claim 1, further comprising a pocket for displaying information such that the information is viewable when the sun visor extender is affixed to the sun visor.

4. The sun visor extender of claim 1, wherein the piece of material is sufficiently stretchy to grip at multiple positions in a sun visor of variable width and sufficiently firm to support itself in the portion of tube not gripping the existing sun visor.

5. The sun visor extender of claim 1, wherein the piece of material is Lycra Spandex.

6. The sun visor extender of claim 1, wherein the piece of material is neoprene.

7. The sun visor extender of claim 1, wherein the piece of material is paper product.

8. The sun visor extender of claim 1, wherein the piece of material is plastic.

9. The sun visor extender of claim 1, wherein the first fastener strip is a Vecro-type loop material and the second fastener strip is a Vecro-type fastener material.

10. The sun visor extender of claim 1, wherein the first fastener strip is wider that the second fastener strip so that by positioning the first strip against the second strip the height of the tube is adjusted based upon where the first fastener strip is positioned with respect to the second fastener strip.

11. A sun visor extender, comprising:
one or more flattened tubes, wherein, in an extended position,
a portion of a first flattened tube of the one or more tubes grips a sun visor and a remaining portion of the first tube serves to increase the effective length of the sun visor by a length equal to a portion of tube not gripping the existing sun visor; and
a portion of each successive flattened tube of the one or more tubes, if there are successive tubes, grips a corresponding previous tube of the one or more tubes such that a remaining portion of each successive tube serves to increase the effective length of the sun visor by a length equal to a portion of each successive tube not gripping each corresponding previous tube.

12. The sun visor extender of claim 11, further comprising information, unrelated to the sun visor extender, printed upon one or more of the one or more tubes such that the information is viewable when the sun visor extender is affixed to the sun visor.

13. The sun visor extender of claim 11, wherein the one or more tubes are a paper product.

14. The sun visor extender of claim 11, wherein the one or more tubes are plastic.

15. The sun visor extender of claim 11 wherein the one or more tubes are neoprene.

16. The sun visor extender of claim 15, wherein the neoprene is sufficiently stretchy to grip the sun visor at multiple positions along the sun visor regardless of variations in the width of the sun visor and sufficiently firm to support itself in the portion of the sun visor extender not gripping the sun visor.

17. The sun visor extender of claim 16, wherein the gripping action is caused by a closeness of a fit between the first tube and the sun visor and, if there are successive tubes, a closeness of fit between each successive tube and a corresponding previous tube.

18. The sun visor extender of claim 11, wherein, in a stored position, the one or more tubes collapse into each other and the sun visor such that the effective length of the sun visor is not extended.

19. A sun visor extender, comprising:
a piece of material; and
one or more clips operable to attach the piece of material to an existing sun visor such that the effective length of the sun visor is increased by a portion of the piece of material that does not overlap the sun visor.

20. The sun visor extender of claim 19, further comprising information, unrelated to the sun visor extender, affixed to the piece of material such that the information is viewable when the sun visor extender is affixed to the sun visor.

21. The sun visor extender of claim 19, wherein the piece of material is a paper product.

22. The sun visor extender of claim 19, wherein the piece of material is plastic.

23. The sun visor extender of claim 19, wherein, in a stored position, the entire piece of material overlaps the sun visor.

24. A sun visor extender, comprising;
a piece of material;
a lip along an edge of the piece of material, wherein
the lip is operable to hook over an edge of a sun visor and thereby affix the material to the sun visor such that the effective length of the sun visor is increased by a portion of the piece of material that does not overlap the sun visor.

25. The sun visor extender of claim 24, further comprising a second parallel lip along a second edge of the piece of material, wherein the second lip is operable to hook over a parallel lip of the sun visor.

26. The sun visor extender of claim 24, further comprising information, unrelated to the sun visor extender, printed upon the sun visor extender such that the information is viewable when the sun visor extender is affixed to the sun visor.

27. The sun visor extender of claim 24, wherein the sun visor extender is plastic.

28. The sun visor extender of claim 24 wherein the sun visor extender is a paper product.

29. The sun visor extender of claim 24, wherein the lip extends the length of the edge of the sun visor extender.

30. The sun visor extender of claim 24, wherein the lip only extends a portion of the length of the edge of the sun visor extender.
